(19) United States
(12) Patent Application Publication
(10) Pub. No.: US 2012/0161464 A1
(43) Pub. Date: Jun. 28, 2012

(54) TENSIONING STAY FOR A COLLAPSIBLE ROOF OF A MOTOR VEHICLE

(75) Inventors: Waleri Katrini, Bietigheim-Bissingen (DE); Marcus Papendorf, Boennigheim (DE); Berthold Klein, Sachsenheim (DE); Randolf Liebhardt, Grafenau (DE)

(73) Assignee: MAGNA CAR TOP SYSTEMS GMBH, Bietigheim-Bissingen (DE)

(21) Appl. No.: 13/336,096

(22) Filed: Dec. 23, 2011

(30) Foreign Application Priority Data
Dec. 24, 2010 (DE) 10 2010 056 247.5

(51) Int. Cl. B60J 7/00

(52) U.S. Cl. 296/107.12

(57) ABSTRACT

A collapsible roof for a vehicle includes a top fabric having a rear region, a tensioning stay arranged underneath the top fabric and attached to the rear region of the top fabric, and a pair of roof guides extending along opposite sides of a roof opening. The top fabric is movably coupled to the roof guides such that the top fabric is movable between a closed position in which the top fabric covers the roof opening and an opened position in which the top fabric is moved rearward away from the roof opening. The tensioning stay is a flat-shaped component that imparts the rear region of the top fabric to have side regions and corner regions.

### CROSS-REFERENCE TO RELATED APPLICATIONS

This application claims foreign priority benefits under 35 U.S.C. §119(a)-(d) to DE 10 2010 056 247.5, filed Dec. 24, 2010, which is hereby incorporated by reference in its entirety.

### TECHNICAL FIELD

The present invention relates to a tensioning stay for a collapsible roof of a vehicle.

### BACKGROUND

A type of a collapsible roof (i.e., a folding top) for a vehicle includes a top fabric (i.e., a fabric cover) and a roof cap. The front of the top fabric is attached to the roof cap. The rear of the top fabric is mounted to the rear of the vehicle body by a tensioning stay and/or a corner bow. The roof (including the top fabric with the roof cap) is movable between a closed position and an opened position. In the closed position, the top fabric covers a roof opening of the vehicle and thereby spans a passenger compartment of the vehicle. The roof cap meets the windshield frame of the vehicle in the closed position. In the opened position, the top fabric and the roof cap are moved rearward away from the roof opening to thereby expose the passenger compartment. The top fabric is folded together and stored with the roof cap thereon in a storage compartment of the vehicle in the opened position. In moving from the closed position towards the opened position, the roof moves rearward from the windshield frame region towards the rear of the vehicle. Conversely, in moving from the opened position toward the closed position, the roof moves forward from the rear of the vehicle towards the windshield frame region. In moving between the closed and opened positions, the roof is displaced along a pair of roof guides respectively positioned on opposite sides of the roof opening. A part of the roof including parts of the fabric cover may protrude to some extent over side regions of the vehicle body adjacent to the roof opening.

The roof further includes convertible top bows to assure shape and stabilization. The top bows are arranged transverse to the direction of vehicle travel (i.e., transverse to the longitudinal direction of the vehicle) and underneath against the top fabric. The top bows prevent sagging or fluttering of the top fabric while the roof is out of the opened position and the vehicle is moving. The top bows are folded together with the top fabric and stored in the storage compartment with the top fabric when the roof is in the opened position.

The top fabric is arranged not only in the horizontal region spanning the passenger compartment, but also extends across the rear region of the vehicle. For example, the top fabric may be deflected by a corner bow to extend across the rear region of the vehicle. A rear window made from a transparent material is generally integrated into the top fabric. The window can be glued, sewn, or fastened in various ways in the opening region of the top fabric.

In addition to the top fabric, the roof cap, the top bows, and the corner bow, the roof further includes a tensioning stay. The tensioning stay is predominantly mounted firmly to the vehicle body in the rear of the vehicle. The tensioning stay forms the rear region of the top fabric that closes in the vicinity of the vehicle body. In specific designs, the tensioning stay is attached pivotably to the vehicle body and is a thin, U-shaped convertible top bow. Such a solution is sought after when the space available for attaching the top fabric in the rear region is relatively small. The top fabric can be attached directly to the vehicle body or in the storage compartment.

DE 197 31 330 A1 describes a movable folding top (i.e., a collapsible roof) for a vehicle. The folding top extends from the windshield cross-member to B-pillars of the rear region of a vehicle. Roof side rails between the windshield and the B-pillars guide the folding top. The roof rails are movably attached to the B-pillars and can be pivoted in the direction of the passenger compartment. In the rear region of the vehicle, a rear roof frame firmly protrudes behind the B-pillars starting from the side B-pillars. The front end of a rear cover is attached to the rear roof. The rear end of the rear cover is attached in the rear region near the body aperture on the vehicle body. The attachment to the vehicle body is carried out by a U-shaped tensioning stay. The tensioning stay is pivotably mounted in the lower region of the B-pillar. The tensioning stay can be pivoted in the direction of the roof frame. The rear cover is folded in the rear region with its side regions. The part of the rear cover pointing toward the B-pillar remains firmly connected. For a closed rear cover, the rear cover is fitted over the tensioning stay and the rear edge of the B-pillar. The rear cover is stretched into the corner between the tensioning stay and B-pillar. The rear cover thus extends beyond the rear region and wraps around the rear side region and is stored in the lower rear region of the vehicle body when the folding top is completely opened. This can give the impression of a convertible top even though the folding top and the rear cover are separated from one another by a roof frame.

DE 101 04 522 C1 describes a folding top having a top fabric movable between the closed and open positions. The displaceability of the roof relates to a horizontal roof opening. The rear region extends between the upper roof region and the upper edge of the vehicle body opening. On the side toward the front, the rear side region is bounded by rigid side pieces in the form of pivotable C-pillars. The side pieces do not form the entire rear side region. The corner region is formed by a portion of the top fabric stretching over the side part and the rear region. The boundary of the side part pointing in the direction of travel is formed by a support element. The support element is a component of the C-pillar. By the support element, the storage compartment in the rear region of the vehicle body is pivoted to completely open the roof. The top fabric is firmly attached to the side piece and forms a stretched fabric corner in the opening region of the vehicle body. In the upper region, the top fabric is attached to the storage compartment. The corner region is composed of the top fabric that is stretched by the formation of the lower and upper corner. During the opening of the rear folding top region, the side parts are pivoted so that the side pieces, the top fabric, and the storage compartment can all be pivoted together into the opening region of the rear vehicle body. When the roof is completely opened, a convertible folding top results. The rear part and a roof element formed from the top fabric are lowered completely into the storage compartment.

DE 10 2004 020 007 describes a collapsible roof that can be closed and opened at least in regions. The roof includes firm plate-shaped roof parts provided in the roof region starting from the upper windshield frame to the region of the C-pillars. The rear region of the vehicle that can be opened and closed is covered by a flexible cover. The cover is attached to the front roof region on a convertible top bow and is installed on side arms extending from the top bow in the rear region of the C-pillar. The arms are firmly fitted to the C-pillars when the rear region is closed. The arms have an articulated joint at the mid position in order to save space during storage. The rear region can be folded together when opening the roof and can be stored in the lower rear region of the vehicle body.

GB 360,415 describes a collapsible roof that can be closed and opened in stages. A roof opening is in the roof in the side window region. The region between the side windows and the roof opening is designed as a roof support for accommodating guide rails. A top fabric can be pushed back from the windshield to near the rear region of the C-pillars. There are no roof supports that connect to the C-pillars. As this region is closed by a cowl type cover that consists of the top fabric. The top fabric is pulled from the rear region through the rear side region until it reaches the C-pillars, with which the top fabric is finished in a sealing manner. The top fabric together with the top fabric that is displaced toward the rear into the rear finishing region of the vehicle body can be pivoted by a U-shaped convertible top bow. The top bow rests on the C-pillar with its edge that points forward and on which the rear side of the top fabric of the rear region is attached. The top bow corresponds in shape to the C-pillar in the contact region so that it serves to apply the fabric tension of the rear region to seal the C-pillar. The top fabric of the rear region is connected to it in the opening region of the vehicle body. The rear side shape and path of the top fabric are not inherent, but are maintained in the stretched position by the top bow. When the roof is closed it gives the impression that the vehicle is a semi-convertible or a landau.

### SUMMARY

An object of the present invention includes a tensioning stay of a collapsible roof of a vehicle in which the tensioning stay has a particularly simple design which makes possible a plurality of shaping and top fabric stretching functions.

In carrying out at least one of the above and other objects, the present invention provides a collapsible roof (i.e., a folding top) for a vehicle. The roof includes a top fabric having a rear region, a tensioning stay arranged underneath the top fabric and attached to the rear region of the top fabric, and a pair of roof guides extending along opposite sides of a roof opening. The top fabric is movably coupled to the roof guides such that the top fabric is movable between a closed position in which the top fabric covers the roof opening and an opened position in which the top fabric is moved rearward away from the roof opening. The tensioning stay is a flat-shaped component that imparts the rear region of the top fabric to have side regions and corner regions.

Further, in carrying out at least one of the above and other objects, the present invention provides a vehicle. The vehicle includes a vehicle body and a collapsible roof. The vehicle body includes a roof opening and a pair of C-pillars adjacent a rear region of the roof opening, the vehicle body further having a storage compartment positioned rearward of the C-pillars. The roof includes a top fabric with a rear region, a tensioning stay arranged underneath the top fabric and attached to the rear region of the top fabric, and a pair of roof guides extending along opposite sides of a roof opening. The top fabric is movably coupled to the roof guides such that the top fabric is movable between a closed position in which the top fabric covers the roof opening and an opened position in which the top fabric is moved rearward away from the roof opening and stored in the storage compartment. The tensioning stay is a flat-shaped component that imparts the rear region of the top fabric with side regions up to the rear edges of the C-pillars and corner regions between the rear edges of the C-pillars and the storage compartment.

Embodiments of the present invention are directed to a collapsible roof (i.e., a folding top) for a vehicle. The roof includes a top fabric, a roof cap, a corner bow, convertible top bows, and a tensioning bow. The front of the top fabric is attached to the roof cap. For example, the top fabric transitions into the roof cap in the forward direction of vehicle travel. The tensioning stay is attached to the rear of the top fabric. The roof (including the top fabric with the roof cap) is movable between a closed position and an opened position. In the closed position, the top fabric covers a roof opening of the vehicle and stretches over the passenger compartment of the vehicle. In the opened position, the top fabric and the roof cap are moved away from the roof opening and stored in a rear storage space of the vehicle to thereby expose the passenger compartment. The roof is movable between the closed and opened positions on side roof guides extending along opposite sides of the roof opening. A rear window is integrated into the rear region of the top fabric. The top bows, the corner bow, and the tensioning stay are underneath against the top fabric. The top fabric stretches over the top bows, the corner bow, and the tensioning stay in the closed position.

The tensioning stay introduces the top fabric from the rear region that imparts a shape to the side region of the vehicle up to the rear edge of the C-pillar of the vehicle. The tensioning stay forms the corner region of the top fabric between the rear edge of the C-pillar and the rear opening region of the vehicle body. The tensioning stay that imparts a shape to the side rear and corner regions is designed as an appropriately flat shaped component. The tensioning stay is intended to unify a plurality of functions and to enable the shaping and tension of the top fabric in a particularly simple design.

Embodiments of the present invention are based on the concept that a collapsible roof is provided to close and open a roof opening of a vehicle. The roof opening extends from the front region of the windshield frame into the rear region below a rear view window. The roof is formed from a top fabric. The shape of the top fabric is maintained in the opening region over the passenger compartment by convertible top bows arranged transverse to the direction of vehicle travel. A rear window is integrated into the top fabric in the rear region of the roof, whereby the top fabric in the rear region is stretched up to the side region near the C-pillar. A shaping corner bow is arranged between the roof that stretches over the passenger compartment and the rear side region of the roof so that the top fabric is deflected over the passenger compartment into a downward sloping rear region. For example, a roof spoiler with integrated tail lights can be installed in or on the top fabric in the immediate vicinity of the corner bow. When opening the roof, the front boundary of the roof on the windshield frame (i.e., a roof cap) is unlocked from its position that is fixed to the windshield frame. The roof cap and the top fabric attached thereto is displaced on side roof guides into the rear region of the vehicle. Upon reaching the rear end region of the roof, the retracted and folded roof, together with the rear region, is lowered into the deeper lying rear region of the vehicle body by a suitable kinematic mechanism.

Up to the vehicle side parts on the vehicle body that include the C-column and the roof side rails. The vehicle is now opened on the roof side and rear side. The roof side rails that are removed by hinges or locking mechanisms between the windshield frame and the C-pillar can be taken out. The result is a full-fledged convertible with only the C-pillars projecting to a point near the upper roof boundary to thereby provide protection similar to that of a roll bar.

The top fabric of the roof is guided in the rear region around side rear corners of the roof up to the rear edge of the C-pillar. The top fabric bears on a seal that is fitted in the edge region of the C-pillar. Due to this lateral wrap-around of the top fabric from the rear region up to the side regions of the C-pillar, the impression is given that the vehicle is a full-fledged convertible. Parts of the C-pillar or the roof guide, as well as supports or support brackets, can be covered by the top fabric when the roof is closed by the top fabric adjacent to the rear edge of the C-pillar. The shaping of the top fabric surrounding the rear region into the side region of the vehicle sets stringent requirements on the guiding of the top fabric and stretching of the top fabric in this transition region. This is made even more difficult since the side region and the rear region of the roof have to transition into the nearly vertical alignment of the upper region of the roof. In order to achieve an attractive appearance, the top fabric in the side and rear regions is formed as a single piece from the upper region of the roof. This is complicated even further since the deflection of the top fabric at the corner bow has different dimensions and curvatures than are exhibited in the region of the tensioning stay near the opening region of the vehicle body. Thus the top fabric has to be almost similar to an elastic foil in order that a corner bow and a rear region can be transformed and stretched into the side region of the vehicle.

A corner of the top fabric between the C-pillar and the opening region of the vehicle body, which coincides with the lower edge of the tensioning stay, affects the stretching of the top fabric in the side rear region. This corner and the side rear region cannot be designed sufficiently well in the conventional manner from a tensioning bow to produce a continuous shape and tension. To do this, the tensioning stay is designed as a shaping piece having curved and cambered surfaces onto which the top fabric is applied by suitable bonding techniques. It is thus possible that the tensioning stay can give rise to the desired shape of the roof in this location in the side rear region and in the corner region and the top fabric is stretched over this flat tensioning stay that creates the shape. It is likewise possible in this manner that the corner of the top fabric can be designed reliably between the C-pillar and the opening region of the vehicle body.

An additional function is that to open a nearly vertically oriented rear hatch below the roof, the tensioning stay with the top fabric attached to it can be pivoted upwardly, so that it is possible to open the rear region to load a storage compartment. When the roof is opened, the tensioning stay also takes over the additional function such that the top fabric applied over the tensioning stay forces a specific folding pattern on the stored and folded roof and thereby causes it to assume a specific storage position during the opening process.

The tensioning stay can only be molded with difficulty in its flat shape because of the shaping transition and stretching behavior of the roof in the rear, corner, and side regions. Injection moldings of light metal or plastic offer the possibility of fabricating such a tensioning stay. The tensioning stay is attached to the top fabric, for example, by gluing, sewing, or other suitable bonding methods. Reliable attachment of the top fabric on the tensioning stay is important because the tensioning stay can be pivoted while loading the rear storage compartment. The top fabric bonded to the tensioning stay is exposed to high tensile stresses in the region of its pivot axis when the folding top is opened as well as closed. In order to keep these loads as small as possible it is desirable to locate the pivot axis near the rear edge of the C-pillar or in the region of the roof guide.

The tensioning stay can be fixed and locked by a lock mechanism with respect to the vehicle body. It can be held in its opened position, for example by an accelerator spring, when the tensioning stay is pivoted in the upward direction. Brake lights or interior lights for the storage compartment can be integrated in the tensioning stay. This is possible due to the large surface and large volume design of the corner regions of the tensioning stay and the middle region of the tensioning stay.

The above features, and other features and advantages of the present invention are readily apparent from the following detailed description thereof when taken in connection with the accompanying drawings. It is understood that the features stated above and to be explained below may be used not only in the particular stated combination, but also in other combinations or alone without departing from the scope of the present invention.

Exemplary embodiments of the present invention are illustrated in the drawings and explained in greater detail in the following description. Identical, similar, or functionally equivalent components are denoted by the same reference numerals.

### BRIEF DESCRIPTION OF THE DRAWINGS

FIG. 1 illustrates a side view of a collapsible roof having a top fabric in accordance with an embodiment of the present invention in which the roof is in a closed position;

FIG. 2 illustrates an oblique isometric view of the roof from the rear in which the roof is in the closed position;

FIG. 3 illustrates a side view of the roof without the top fabric in which the roof is in an opened position; and

FIG. 4 illustrates an oblique isometric view of the roof without the top fabric from the rear in which the roof is in the opened position.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

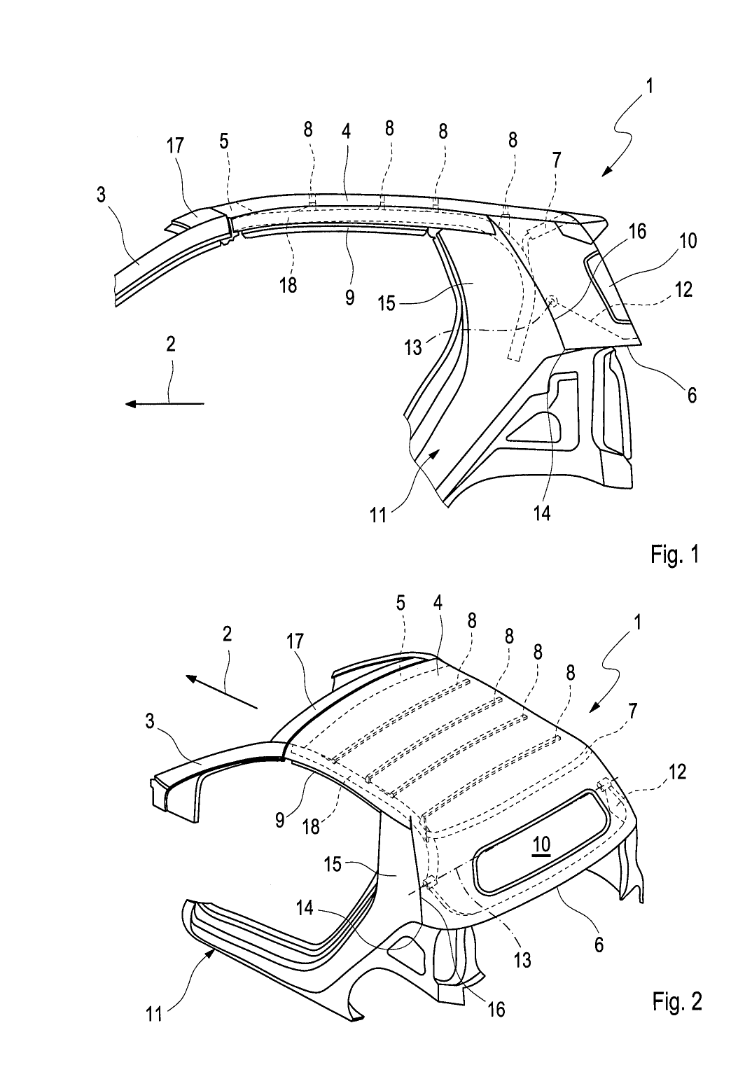

Referring now to FIG. 1, a collapsible roof 1 (i.e., a folding top) for a vehicle in accordance with an embodiment of the present invention will be described. Roof 1 includes a top fabric 4, a roof cap 5, a corner bow 7, a plurality of convertible top bows 8, and a tensioning stay 12. The front of top fabric 4 is attached to roof cap 5. The rear of top fabric 4 is mounted to vehicle body 11. Roof 1 (including top fabric 4 with roof cap 5) is movable between a closed position and an opened position. In the closed position, top fabric 4 covers a roof opening of vehicle body 11 to thereby span over the passenger compartment of the vehicle. In the opened position, top fabric 4 and roof cap 5 are moved away rearward from the roof opening to thereby expose the passenger compartment.

In FIG. 1, roof 1 is in the closed position and extends from windshield frame 17 of vehicle body 11 into the rear region of the vehicle. Windshield frame 17 is a transverse connection of A-pillar 3 of vehicle body 11. Roof cap 5 meets and engages with windshield frame 17 to lock roof 1 in the closed position. The path and curvature of roof 1 makes a smooth transition in windshield frame 17 and A-pillar 3. In the closed position, top fabric 4 surrounds the side roof region and extends to the side windows. Roof side rails 9 form the side roof region. Roof side rails 9 are an extension of A-pillar 3 that connects to C-pillar 15 of vehicle body 11.

A roof guide 18 for enabling roof 1 to displace between the closed and opened positions is mounted on each roof side rail 9 pointing toward the roof opening. In the opened position, roof side rails 9 can be removed from the positions where they are connected. Roof side rails 9 have fasteners or hinges on their ends. The ends of roof side rails 9 firmly connect roof side rails 9 with windshield frame 17 (A-pillar 3) and C-pillar 15. Roof guide 18 is provided in the region of roof side rails 9 and is sized according to the roof side rail dimensions. Roof guide 18 has a transition region to rear roof guide 18 in C-pillar 15 in the gap from roof side rails 9 to C-pillar 15.

The rear region of roof 1 pointing rearward (i.e., opposite to the direction of forward vehicle motion) has a downward facing slope. Tensioning stay 12 or the opening region of vehicle body 11 limit the rear region of roof 1 (i.e., top fabric 4).

Corner bow 7 is arranged against beneath top fabric 4 in the transition region between the horizontally extended roof 1 and the rear region of roof 1. Top fabric 4 is transitioned over corner bow 7 from the nearly horizontal position that stretches over the passenger compartment into the downwardly sloped rear region. A rear spoiler can be placed on top fabric 4 in this rear region. Corner bow 7 can form the spoiler. A rear window 10 is in the rear region of top fabric 4. Window 10 can be fabricated from a transparent plastic material or glass.

The portion of top fabric 4 carried over from the rear region into the side region of the vehicle is bounded near rear edge 16 of C-pillar 15. Top fabric 4 in the side region bears on a seal located on C-pillar 15. Tensioning stay 12 is in the lower rear region of roof 1 to produce tension in the material of top fabric 4 and to impart a shape to top fabric 4. Tensioning stay 12 can pivot about pivot axes 13 on respective sides of vehicle body 11 as roof 1 moves between the closed and opened positions. Tensioning stay 12 is formed as a multiply curved and cambered shaping frame. The shape of tensioning stay 12 corresponds to the desired shape and path of top fabric 4 in the rear corner region or the side rear region. Top fabric 4 is firmly attached to tensioning stay 12.

Roof 1 forms a corner 14 between rear edge 16 and C-pillar 15 and the opening region of vehicle body 11. Corner 14 is important in its shape and position for determining the tension in the rear top fabric 4. In order to assure an appropriate attachment of top fabric 4 to the lower edge of tensioning stay 12, top fabric 4 is designed as a fabric edge 6 in this region. Fabric edge 6 can contain a welting or other fastening aid, for example, through special arrangements that are passed around the edge of tensioning stay 12. Fabric edge 6 strengthens top fabric 4 since this edge is exposed to high tensile forces when roof 1 is in the closed position.

FIG. 2 illustrates an oblique isometric view of roof 1 from the rear in the closed position. Top bows 8 are arranged below top fabric 4 to prevent top fabric 4 from sagging when roof 1 is in the closed position and to provide shape to roof 1. Top bows 8 are arranged below top fabric 4 perpendicularly to the direction of vehicle travel 2. Top bows 8 are generally connected to top fabric 4 by movable connections. Top bows 8 can be displaced in roof guides 18. Top bows 8 can be individually raised and pivoted by appropriate mechanisms corresponding to a folding bow.

Corner bow 7 deflects top fabric 4 to fabric edge 6 of tensioning stay 12 in the rear roof region. Tensioning stay 12 can be pivoted out of its closed position into a position near corner bow 7 through pivot axis 13, which corresponds to roof 1 in the closed position. The resulting folds for the rear top fabric 4 are controlled by the shaping and physical form of tensioning stay 12 and the positioning of pivot axis 13. As such, rear window 10 pivots into a predetermined position without subjected to damage by contact due to skidding or pressure with other roof pieces or vehicle parts.

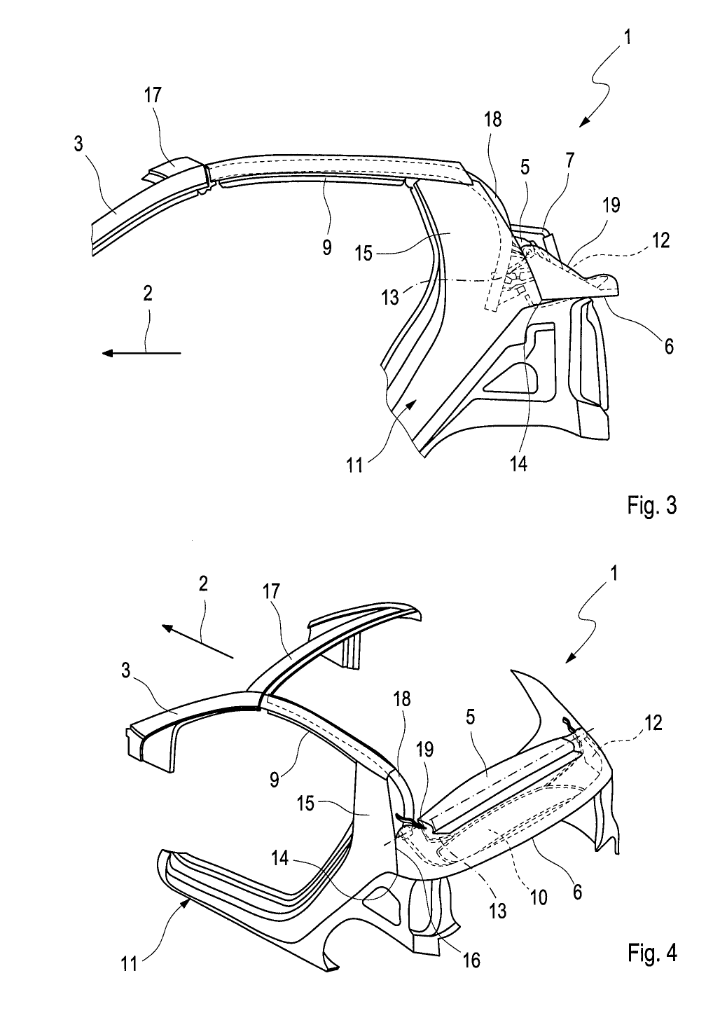

FIG. 3 illustrates a side view of roof 1 in the opened position. In the opened position, tensioning stay 12 lies over the opening region of vehicle body 11. Tensioning stay 12 can be locked by a lock mechanism with vehicle body 11. According to the path of the top fabric edge pointing in the direction of vehicle travel 2 along rear edge 16 of C-pillar 15, pivot axis 13 is arranged nearby by a support on vehicle body 11 or roof guide 18. Tensioning stay 12 pivots about pivot axis 13 when the rear storage compartment of vehicle body 11 is to be loaded and tensioning stay 12 is moved into an upwardly pivoted position. The position of tensioning stay 12 depicted in FIG. 3 corresponds to its position for an opened or closed folding top. The approximate path of folded top fabric 19 can be seen for roof 1 in the opened position. This folded top fabric 19 just passes over the upper edge of tensioning stay 12 so that it can be deflected in the region of the folded and stored roof 1. Roof 1 that is stored here in the rear region has been pushed along roof rails 18 into the rear region. Roof 1 was moved into the storage position through top bows 8 and kinematic mechanisms. The integrated assimilation of roof guide 18 in roof side rail 9 is also shown in FIG. 3. Roof side rail 9 can be released from its lock mechanism in the region of windshield frame 17 and the C-pillar so that roof side rail 9 can be removed along with a part of roof guide 18.

As can be seen in FIG. 3, it is also the case in FIG. 4 that corner bow 7 is pivoted inwardly for roof 1 in the opened position. This results in top fabric 4 being pressed into the storage position by corner bow 7. Corner bow 7 is also caused to move in order that roof 1 moving over the storage region moves with it. Corner bow 7 can be pivoted through its own control lever kinematic system that is active in this position.

FIG. 4 illustrates an oblique isometric view of roof 1 in the opened position. This view shows the storage position of rear window 10 when roof 1 is in the opened position. The stored folded top fabric 4 and roof 5 are likewise shown. Roof cap 5 comes to rest as the last element on the top fabric 4. Top fabric 4 and roof cap 5 are locked here with respect to roof guide 18. In this position, tensioning stay 12 can be moved at least partially into an upwardly pivoted position. The shaping of tensioning stay 12 when roof 1 is in the opened position causes top fabric 4 in the side corner region of the vehicle to be positioned at least partially according to the prescribed shape of tensioning stay 12. As a result, corner 14 of top fabric 4 is formed precisely. Since the largest part of roof 1 is stored inside the inclusion region of tensioning stay 12, stored roof 1 is essentially hidden by the shape imparted by tensioning stay 12. As such, only tensioning stay 12 surrounded with material and roof cap 5 is visible from the outside. Top fabric 4 in the region of tensioning stay 12 is also attached to it in this position so that annoying noises from top fabric 4, e.g., due to fluttering of top fabric 4, due to the wind produced while driving are prevented.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A collapsible roof for a vehicle comprising:
a top fabric having a rear region;
a tensioning stay arranged underneath the top fabric and attached to the rear region of the top fabric; and
a pair of roof guides extending along opposite sides of a roof opening, wherein the top fabric is movably coupled to the roof guides such that the top fabric is movable between a closed position in which the top fabric covers the roof opening and an opened position in which the top fabric is moved rearward away from the roof opening;
wherein the tensioning stay is a flat-shaped component that imparts the rear region of the top fabric to have side regions and corner regions.

2. The roof of claim 1 further comprising:
a rear window integrated into the rear region of the top fabric.

3. The roof of claim 1 further comprising:
a plurality of convertible top bows arranged underneath the top fabric, wherein the top fabric stretched over the convertible top bows when the top fabric is in the closed position.

4. The roof of claim 1 wherein:
the tensioning stay is pivotable about a pivot axes between a lowered position and a raised position.

5. The roof of claim 4 wherein:
the pivot axes are positioned on the roof guides.

6. The roof of claim 1 wherein:
the rear region of the top fabric includes a fabric edge;
wherein the tensioning stay is attached to the fabric edge of the top fabric.

7. The roof of claim 1 wherein:
the tensioning stay includes at least one of plastic and metal.

8. The roof of claim 1 wherein:
the tensioning stay is curved.

9. A vehicle comprising:
a vehicle body having a roof opening and a pair of C-pillars adjacent a rear region of the roof opening, the vehicle body further having a storage compartment positioned rearward of the C-pillars;
a collapsible roof having a top fabric with a rear region, a tensioning stay arranged underneath the top fabric and attached to the rear region of the top fabric, and a pair of roof guides extending along opposite sides of a roof opening, wherein the top fabric is movably coupled to the roof guides such that the top fabric is movable between a closed position in which the top fabric covers the roof opening and an opened position in which the top fabric is moved rearward away from the roof opening and stored in the storage compartment;
wherein the tensioning stay is a flat-shaped component that imparts the rear region of the top fabric with side regions up to the rear edges of the C-pillars and corner regions between the rear edges of the C-pillars and the storage compartment.

10. The vehicle of claim 9 further comprising:
a rear window integrated into the rear region of the top fabric.

11. The vehicle of claim 9 further comprising:
a plurality of convertible top bows arranged underneath the top fabric, wherein the top fabric stretched over the convertible top bows when the top fabric is in the closed position.

12. The vehicle of claim 9 wherein:
the tensioning stay is pivotable about a pivot axes between a lowered position and a raised position.

13. The vehicle of claim 12 wherein:
the pivot axes are positioned on the C-pillars.

14. The vehicle of claim 9 wherein:
the rear region of the top fabric includes a fabric edge;
wherein the tensioning stay is attached to the fabric edge of the top fabric.

15. The vehicle of claim 9 wherein:
the tensioning stay includes at least one of plastic and metal.

16. The vehicle of claim 9 wherein:
the tensioning stay is curved.

17. The vehicle of claim 9 wherein:
the tensioning stay can be fixed to bear on the storage compartment by a lock in the position of its lower edge.

18. The vehicle of claim 9 wherein:
the tensioning stay holds the portions of the top fabric abutting the rear edges of the C-pillars in a sealing position with respect to the C-pillars.

19. The vehicle of claim 9 wherein:
the tensioning stay is pivotable between a lowered position and a raised position, wherein the tensioning stay pivots to the lowered position when the top fabric is in the closed position to thereby impart the rear region of the top fabric with the side regions and the corner regions.

20. The vehicle of claim 9 wherein:
the roof further includes a roof, wherein the top fabric includes a front region, wherein the front region of the top fabric is attached to the roof cap.
